(19) United States
(12) Patent Application Publication
(10) Pub. No.: US 2022/0049390 A1
(43) Pub. Date: Feb. 17, 2022

(54) MEDICAL PROTECTIVE CLOTHING FABRIC

(71) Applicant: Chuan Yu HUANG, Taichung City (TW)

(72) Inventor: Chuan Yu HUANG, Taichung City (TW)

(21) Appl. No.: 16/993,190

(22) Filed: Aug. 13, 2020

(51) Int. Cl. D04H 1/60; D04H 3/005

(52) U.S. Cl. CPC D04H 1/60; D04H 3/005; D10B 2501/04; D10B 2321/022; D10B 2509/00; D10B 2321/042

(57) ABSTRACT

A medical protective clothing fabric includes a Teflon fabric and a petrochemical synthetic filament fabric bonded to the Teflon fabric, where the Teflon fabric and petrochemical synthetic filament fabric are heated and bonded together with high frequency and high pressure, and the fabric hole density of the Teflon fabric is 0.05 μm to 0.1 μm. Whereby, the infectious substances can be prevented from penetrating through the Teflon fabric, and since the Teflon fabric has high temperature resistance, it is not easy to melt, deform or break in a high temperature environment. With the bonding processed with high frequency and high pressure, the processing is simple, the processing cost is significantly reduced, pinholes can further be prevented from being produced, and infectious substance is prevented from penetrating through pinholes. Furthermore, the petrochemical synthetic filament fabric improving wearing comfort allows the medical protective clothing fabric to be waterproof and air permeable.

### (a) TECHNICAL FIELD OF THE INVENTION

The present invention relates to a fabric structure, and more particularly to a medical protective clothing fabric.

### (b) DESCRIPTION OF THE PRIOR ART

With the growth of the elderly population and the increasing incidence of infectious and chronic diseases, the demand for medical care is increasing. To maintain the quality of medical care, and therefore, the issue of how to protect medical staff from being infected during the care process has gradually attracted public attention. At present, in addition to wearing masks, isolation protective clothing is the most important medical wear that can effectively. prevent infection and maintain health. The above isolation protective clothing is used for the protection of the health of medical staff, in order to effectively prevent medical staff from being contaminated by the patient's blood, body fluids, microorganisms, etc. or infectious substances in the environment when caring for the patient. At the same time, it can also prevent the external environment from being infected by the wearer, making the isolation protective clothing one of the indispensable medical necessities. However, the common medical isolation protective clothing, at present, is mainly for one-time use; namely, it cannot be washed with high temperature hot water, detergent or disinfectant, and thus cannot be reused, which can reduce the spread of infectious substances, but causes an increase in medical waste, being not in line with the concept of environmental sustainability. Furthermore, the fabric material of the isolation protective clothing is mainly composed of polyethylene (PE) as the outer layer, plus non-woven fabric as the inner layer, which may allow it to have a waterproof function to prevent the penetration of infectious substances, but also have disadvantages such as the lack of moisture and air permeability; it cannot be worn too long, or an oxygen cylinder is required when wearing it. In addition, polyethylene (PE) will start to deteriorate at a temperature above 70 degrees, and melt and deform at a temperature above 100 degrees, which not only causes the isolation protective clothing to be easily damaged and broken by foreign objects, but may cause protection gaps and endanger the wearer's health. In addition, the fabrics of the isolation protective clothing are fixed by sewing, but since the sewing will produce pinholes, it is necessary to additionally seal the pinholes with polyethylene film to prevent the penetration of infectious substances from the pinholes, which, however, leads to cumbersome and time-consuming and labor-intensive processing, and also increases processing costs, such that improvements are needed.

### SUMMARY OF THE INVENTION

One object of the present invention is to provide a medical protective clothing fabric, capable of being reused after cleaning and sterilization, and having the characteristics of waterproofing and air permeability, and further improving wearing comfort, simplifying processing and reducing processing cost.

To achieve the above object, the present invention proposes a medical protective clothing fabric, including a Teflon fabric and a petrochemical synthetic filament fabric bonded with the Teflon fabric, where the Teflon fabric and petrochemical synthetic filament fabric are heated and bonded together with high frequency and high pressure, and the fabric hole density of the Teflon fabric is 0.05 μm to 0.1 μm. Whereby, the infectious substances can be prevented from penetrating through the Teflon fabric, and since the Teflon fabric has high temperature resistance, it is not easy to melt, deform or break in a high temperature environment. In addition, with the bonding processed with high frequency and high pressure, the processing is simple, the processing cost is significantly reduced, pinholes can further be prevented from being produced, and infectious substance is prevented from penetrating through pinholes. Furthermore, the petrochemical synthetic filament fabric improving wearing comfort allows the medical protective clothing fabric to be waterproof and air permeable, and to be able to be reused after cleaning and sterilization, further achieving an environmentally friendly effect.

### BRIEF DESCRIPTION OF THE DRAWINGS

FIG. 1 is a schematically prospective view of a preferred embodiment of the present invention.

### DETAILED DESCRIPTION OF THE PREFERRED EMBODIMENTS

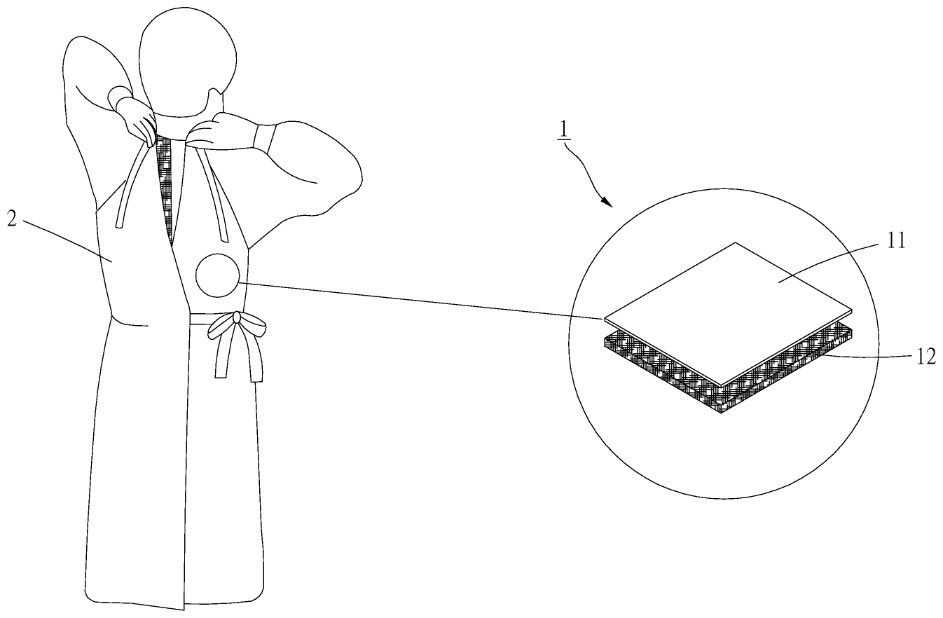

Referring to FIG. 1, a medical protective clothing fabric 1 of the present invention, in a preferred embodiment, includes a Teflon fabric 11, and a petrochemical synthetic filament fabric 12 bonded to the Teflon fabric 11, where the Teflon fabric 11 and petrochemical synthetic filament fabric 12 are heated and bonded to each other with high frequency and high pressure, the fabric hole density of the Teflon fabric 11 is 0.05 μm to 0.1 μm, the material of the Teflon fabric 11 is Polytetrafluoroethene (PTFE) , and the material of the petrochemical synthetic filament fabric 12 may be nylon (polyester) , acrylic fiber (polyacrylonitrile fiber) , Polypropylene, or the like.

Furthermore, the medical protective clothing fabric 1 can be used to make medical isolation protective clothing 2. As FIG. 1 shows, the petrochemical synthetic filament fabric 12, upon use, is used as a n inner layer; namely, the surface of the petrochemical synthetic filament fabric 12 is in contact with a wearer's skin, so that the wearing comfort can be significantly improved through the characteristics of skin affinity, softness and comfort of the synthetic long fiber fabric 12. Furthermore, with the waterproof feature of the Teflon fabric 11, it can be used as an outer layer, which not only effectively prevent the wearer from being directly exposed to infectious substances, but also at the same time, infectious substances from penetrating, further reducing the risk of the spread of infectious substances. In addition, since the Teflon fabric 11 can resist high temperature (130 degrees Celsius), it is not easy to melt, deform or break in a high temperature environment, further preventing the generation of protection gaps, and effectively protecting the wearer's health. Furthermore, the Teflon fabric 11 and petrochemical synthetic filament fabric 12 are heated and bonded together with high frequency and high pressure, which not only makes the processing process easier, but greatly reduces the processing cost. At the same time, the high-frequency and high-pressure bonding method can effectively avoid pinholes generate. Therefore, infectious substances will not penetrate through the pinholes, and will also not pollute the wearer's skin, further promoting the overall protection effect, so that the medical protective clothing fabric 1 not only has the characteristics of waterproofing and air permeability, and can be reused after cleaning and sterilization, but achieve an environmentally friendly effect.

Conclusively, the medical protective clothing fabric of the present invention not only can effectively prevent the penetration of infectious substances, but is not easy to melt, deform and break in a high temperature environment through the characteristics of the waterproofing and high temperature resistance of the Teflon fabric 11. With the heating and bonding with high frequency and high pressure, the present invention allows not only the processing to be simple, the processing cost to be reduced and the generation of pinholes to be prevented, but prevent infectious substances from penetrating through the pinholes. Furthermore, the wearing comfort can be enhanced through the petrochemical synthetic filament fabric 12, allowing the medical protective clothing fabric have the characteristics such as waterproofing and air permeability, and to be able to be reused after cleaning and sterilization, further achieving an environmentally friendly effect.

I claim:

1. A medical protective clothing fabric, comprising a Teflon fabric and a petrochemical synthetic filament fabric bonded to said Teflon fabric, wherein said Teflon fabric and petrochemical synthetic filament fabric are heated and bonded together with high frequency and high pressure, and the fabric hole density of said Teflon fabric is 0.05 μm to 0.1 μm.

2. The medical protective clothing fabric according to claim 1, wherein the material of said petrochemical synthetic filament fabric is nylon, acrylic fiber or Polypropylene.
